(19) United States
(12) Patent Application Publication
(10) Pub. No.: US 2002/0182559 A1
(43) Pub. Date: Dec. 5, 2002

(54) Bracket for orthodontic use

(76) Inventor: Curtis Kamisugi, Honolulu, HI (US)

Correspondence Address: OSTROLENK FABER GERB & SOFFEN, 1180 AVENUE OF THE AMERICAS, NEW YORK, NY, 100368403

(21) Appl. No.: 09/871,292

(22) Filed: May 30, 2001

(51) Int. Cl. A61C 3/00

(52) U.S. Cl. 433/9; 433/8

(57) ABSTRACT

A bracket for orthodontic use includes a base having a face adapted to be mounted to an inside surface of a tooth; and a stem having a first end connected to the base, the stem including a spur connected to a second end of the stem such that when the base is mounted to the inside surface of the tooth, the spur is located rearwardly of the face and oriented in the rearward direction. A method for prevention of tongue thrust swallowing includes providing a bracket having a spur, mounting the bracket on a rear surface of a tooth that is substantially opposing the tongue, and orienting the spur in a direction substantially opposing the tongue to discourage tongue thrust during swallowing.

### BACKGROUND OF THE INVENTION

1. Field of the Invention

This invention relates to a method and a device for discouraging tongue thrust swallowing and thus preventing and correcting anterior openbite malocclusions.

2. Description of the Related Art

When swallowing, the tongue is first positioned against the front of the palate behind the front teeth, and then it is moved upwards and backwards against the palate. Tongue thrust problems develop as a result of placing the tongue too low and too far forward in the mouth which results in moving the tongue against and in front of the front teeth at the end of swallowing.

Tongue thrusting may also occur during speech. Recent scientific research has shown that tongue thrusting during swallowing or speech is an adaptive technique that is used to create an anterior seal. During each tongue thrust, the tongue applies pressure to the front teeth for a duration of time. The repeated application of the pressure can contribute to the upward and forward displacement of the upper front teeth and their surrounding bone, which results in the creation of an open space between the upper and lower front teeth. This condition is known as anterior openbite malocclusion.

FIG. 1 illustrates the relative positioning of a tongue 50, upper front teeth 20 and lower front teeth 30. Upper and lower front teeth shown in FIG. 1 do not exhibit anterior openbite malocclusion. FIG. 1A shows the relative positions of upper front teeth 20 and lower front teeth 30 shown in FIG. 1 in a closed position. In contrast to FIG. 1, upper front teeth 20 and lower front teeth 30 are shown as having the anterior openbite malocclusion condition. Shaded areas 20A, 30A indicate the positions that these teeth should have when the mouth is closed. For example, shaded area 20A shows the position of a normal upper front tooth and the shaded area 30A shows the position of a normal lower front tooth. An upper molar tooth 10 and a lower molar tooth 10A are shown to be in contact in order to demonstrate the relative positions of upper front teeth 20 and lower front teeth 30 when the mouth is closed. As shown in FIG. 1A, upper front teeth 20 and lower front teeth 30 are spaced apart greatly.

To prevent the development of anterior openbite malocclusion various solutions have been proposed. U.S. Pat. No. 5,779,470, for example, has proposed an oral corrective device that is retained by the posterior teeth to condition the tongue to refrain from tongue thrusting during swallowing. The device proposed includes a teeth-fitting segment which is adapted to fit under an upper posterior teeth of a patient, a palatal bridge extending from this segment and adapted so that it may not contact the palate of the patient, and a downward projection adapted to create a rearwardly opening pouch or channel which “engulf” the patient's tongue. When the device is fitted into a patient's mouth by tightly fitting it onto the patient's posterior teeth, the pouch or channel positions the tongue properly and accurately to imitate a normal swallow. To properly employ the device shown, the device must be fitted to a patient's mouth. The fitting process involves, among other steps, molding a polymerization material onto the device and around the patient's posterior teeth and then curing the material into a resilient solid conforming to the shape of the patient's teeth. As is evident this device needs to be customized for each patient which may be costly and time consuming.

As another solution for preventing anterior openbite malocclusion, a rake-like device may be installed on the back side of upper front teeth of a patient to discourage or prevent the tongue thrust habit. FIG. 2 shows such a device. As shown, rake-like device 60 includes two anchor portions 70, 70A each integrally joined to an end of a main wire 75, and a plurality of spur portions 80 integrally joined to main wire 75 at one end. In the example shown in FIG. 3, main wire 75 is curved so as to substantially follow the contour of the row of upper front teeth 20. The spurs include a tip portion 80A. Tip portion 80A of each spur is oriented to substantially face the patient's tongue. Each one of anchor portions 70, 70A is secured around a respective molar tooth 10, 10B, in order to securely mount the device inside of the patient's mouth. Once mounted, spurs 80 essentially hang off of main wire 75 with tip portions 80A hanging down from main wire 75 and facing the patient's tongue. In such a position, tip portions 80A of spurs 80 intercept the tongue thrust of the patient thereby discouraging the tongue thrust swallowing habit which causes anterior openbite malocclusion.

Such rake-like devices must also be customized for each patient as the position of the anchoring molar teeth and the number, position and size of the spurs for each patient varies. In addition, the device 60 must be carefully installed to ensure that all spurs 80 substantially face the patient's tongue, and are positioned substantially behind upper front teeth of the patient to properly intercept the tongue. These customization steps are time consuming and may cause the patient discomfort during the installation of the device.

In addition, if other corrective devices such as braces are being used on the patient's teeth, the device will have to be taken out and resized. This situation is demonstrated in FIGS. 3A and 3B. As shown in FIG. 3A, a brace 40 which is installed on the outer surface of upper front teeth of the patient is tightened to close the gaps 45A, 45B in the teeth. The direction of the movement of the teeth for closing gaps 45A, 45B is shown by the arrows. As gaps 45A, 45B are closed, main wire 75 gets closer to the interior surface of upper front teeth 20. To avoid having main wire 75 run into the interior surface of upper front teeth, device 60 has to be taken out so that main wire 75 can be shortened as shown in FIG. 3B. This too is time consuming, and the re-installation requires adjustments which may cause the patient further discomfort.

Therefore, it is desirable to have a method for preventing anterior openbite malocclusion through discouragement of tongue thrusting during swallowing. It is also desirable to have a device for discouraging tongue thrusting during swallowing that is convenient to install and adjust to minimize a patients discomfort.

### SUMMARY OF THE INVENTION

One aspect of the present invention involves a bracket that includes a base that is adapted to be mountable to an inside surface of a tooth, and a stem having a first end connected to the base. The stem includes a spur connected to a second end of the stem and oriented in a direction away from the face.

In another respect the present invention involves a method for prevention of tongue thrust swallowing including providing a bracket having a spur, mounting the bracket on a rear surface of a tooth that is substantially opposing the tongue, and orienting the spur in a direction substantially opposing the tongue to discourage tongue thrust during swallowing.

Other features and advantages of the present invention will become apparent from the following description of the preferred embodiments which refers to the accompanying drawings.

### BRIEF DESCRIPTION OF THE DRAWINGS

For the purpose of illustrating the preferred embodiments, there is shown in the drawings an embodiment which is presently preferred; it being understood, however, that the invention is limited to the precise arrangements and instrumentalities shown.

FIG. 1 is a profile illustration of the relative positioning of an individual's teeth and tongue.

FIG. 1A is a profile illustration of the upper and lower rows of teeth in a closed position.

FIG. 2 is an illustration of a row of upper front teeth having installed thereon a device for prevention of anterior openbite malocclusion according to the prior art.

FIG. 3A is an illustration of a row of upper front teeth having installed thereon a device for prevention of anterior openbite malocclusion according to the prior art and a brace for closure of gaps between the teeth.

FIG. 3B is an illustration of a row of upper front teeth having installed thereon a device for prevention of anterior openbite malocclusion according to the prior art and a brace that has closed the gaps between the teeth shown in FIG. 3A.

FIG. 4A is a side view of a bracket according to the present invention.

FIG. 4B is a front view of a bracket according to the present invention.

FIG. 4C is a back view of a bracket according to the present invention.

FIG. 5 is an illustration of a row of upper front teeth having installed thereon brackets according to the present invention and a brace for closing the gaps between the teeth.

FIG. 6 is a profile illustration showing the brackets of the present invention installed on the teeth.

FIG. 7 is an illustration of a row of upper front teeth having installed thereon brackets according to the present invention and a brace for closing the gaps between the teeth.

FIG. 8 is the row of upper front teeth having brackets installed thereon according to the present invention as shown in FIG. 7 after the gaps have been closed.

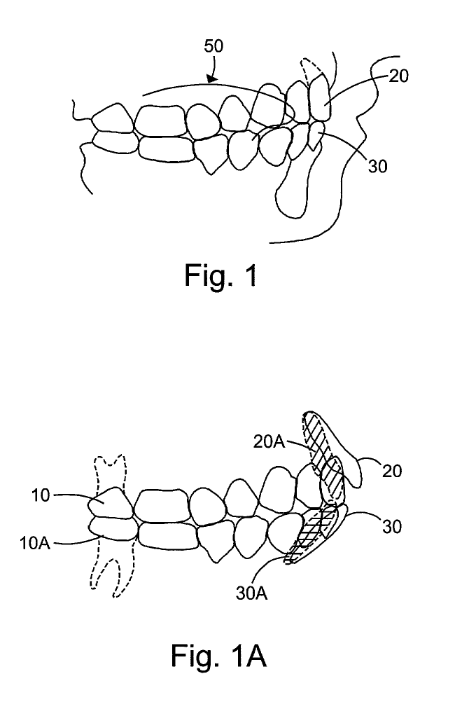

### DETAILED DESCRIPTION OF THE PREFERRED EMBODIMENTS

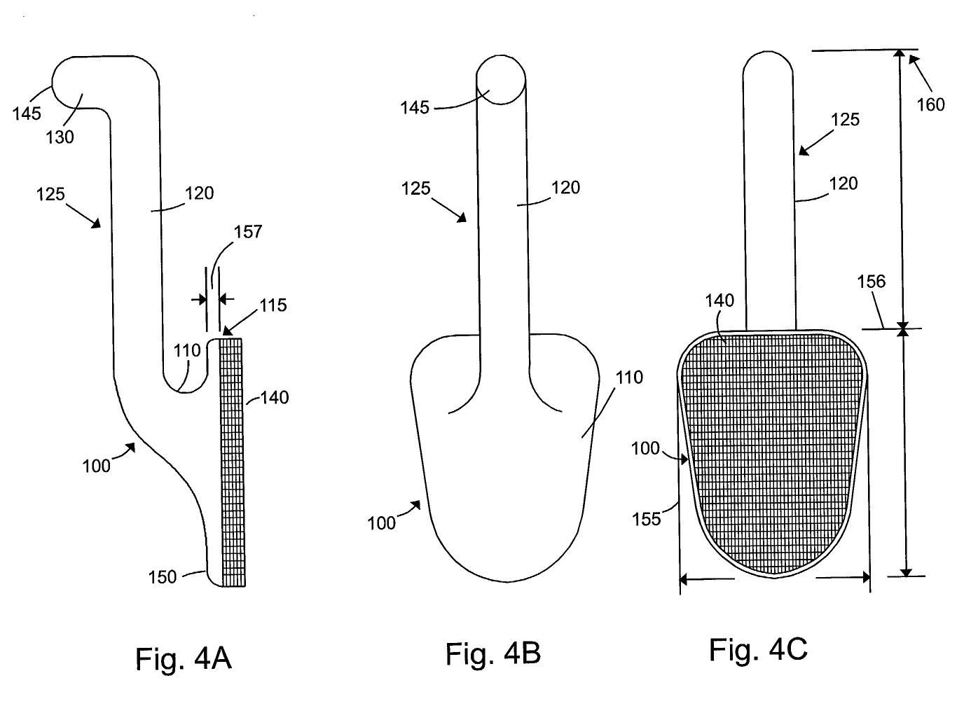

Referring now to the drawings wherein like numerals indicate like elements, FIGS. 4A-C show a bracket 100 according to the present invention. Bracket 100 can be manufactured with any of the known materials using any of the known methods. Bracket 100 includes a base portion 110 and a stem 125. Stem 125 includes an extension rod 120 and a spur 130. Base portion 110, extension rod 120 and spur 130 form bracket 100 having a unitary body.

Base portion 110 includes a substantially flat surface 115. A mesh pad 140 is attached to the flat surface 115 of base portion 110 by, for example, casting or welding. Mesh pad 140 is preferably made from stainless steel. Mesh pad 140 is utilized to adhere bracket 100 to a patient's tooth to retain the same in place, although it is within the scope of the present invention to adhere bracket 100 to a tooth using any other suitable methods.

Stem 125 is oriented substantially parallel to and spaced away from a surface 115 of base 110. Spur 130 is formed by bending stem 125 to a desired angle such that the tip 145 of a spur 130 is spaced away from surface 115 of base 110 at a distance. Stem 125 may be made from a semi-malleable material so that it may be bent, cut or otherwise modified to a desired shape and height. Stem 125 may be preferably made with stainless steel. Spur 130 is oriented so that it is projecting away from the plane of surface 115 of base 110 of bracket 100. Preferably, spur 130 will be oriented substantially along a direction that is perpendicular to the plane of surface 115. When oriented in this direction tip 145 of spur 130 will be spaced at a maximum distance away from surface 115 of base 110.

Base portion 110 includes a base pad 150. The base pad 150 has a maximum width 155 (FIG. 4C) a maximum height 156 (FIG. 4C) and a thickness 157 (FIG. 4A). Preferably, bracket 100 has a maximum height 160 which is the distance between the outermost position on base pad 150 and the outermost position on extension portion 120. Maximum width 155 and maximum height 156 of base pad 150 should be such that the area of the surface 115 (and thus the area of the surface of mesh pad 140) will be small enough to fit on a surface of an individual tooth. Maximum height 160 of bracket 100 should be small enough so that bracket 100 will not interfere with the closing of the patient's mouth. Maximum height 160 may be adjusted by cutting stem 125, or bending its end into a shape of a spur and smoothing the tip of the spur before mounting a bracket onto a patient's tooth.

Preferably, stem 125 is comprised of a substantially cylindrical body which has a spur 130 with a dome-shaped distal end, for example tip 145, as shown in FIG. 4A. The cylindrical body has a substantially uniform diameter. The diameter of the body is preferably about 1 mm. Preferably, the remaining dimensions of the bracket are as follows: thickness of base pad is about 0.25 mm; maximum width 155 of base pad 150 is about 3.5 mm; maximum height 156 of base pad 150 is about 4-5 mm; and maximum height of bracket 100 is about 9.5 mm. Furthermore, the maximum distance between tip of spur 145 and surface 115 of base portion 110 is preferably about 3 mm, and extension portion 120 is spaced about 1 mm away from surface 115 of base portion 110. Spur 130 is preferably 1 mm in length and a maximum of 1 mm in diameter.

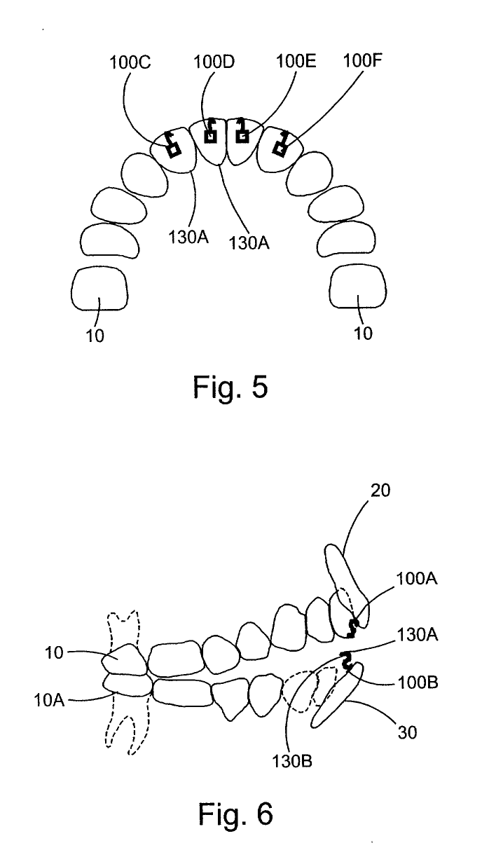

Referring now to FIG. 5, in use, a plurality of brackets 100C, 100D, 100E, 100F according to the invention are mounted on the inner surface of frontal teeth of a patient by any of the known methods. The number and location of brackets mounted on a patient's teeth depend on the severity of the openbite malocclusion and their respective locations. For example, to treat lateral openbite malocclusion, brackets could be mounted on side teeth. Preferably, in an ordinary case of openbite malocclusion, six brackets may be mounted on the upper front teeth, and six on the lower front teeth of the patient. Preferably, brackets 100C, 100D, 100E, 100F may be mounted by applying a dental adhesive to a mesh pad (not shown) disposed on a base of each bracket and attaching the same to the inner surface of a tooth. The dental adhesives used may be self-cured or light-cured. Dental adhesives commercially available from any of the known suppliers such as adhesives sold under trademarks RELY A BOND™, TRANSBOND™, CONCISE™, and ENLIGHT™ may be used to adhesively mount a bracket 100. Preferably, light-cured dental adhesives available from any of the know suppliers such as dental adhesives sold by 3M under the trademarks TRANSBOND™XT, and TRANSBOND™LR may be used. The latter are advantageous in that they are cured by application of a UV light after a bracket is positioned in a proper place on a tooth. To apply the UV light, preferably, a light curing unit, such a light curing unit sold by 3M under the trademark ORTHOLU™XT may be used. Of course, other UW-curable adhesives and UV light curing units may be used to adhesively mount a bracket 100.

Spurs 130 (see FIG. 4A) of each one of the brackets 100C, 100D, 100E, 100F may be reoriented as desired by twisting its extension rod 120 or otherwise deforming its stem 125 portion prior to mounting. In this way, the patient may be spared the discomfort of adjustments of the orientation of the spurs. Once mounted, spurs on the brackets 100C, 100D, 100E, 100F will be opposing the patient's tongue. The area of a base pad for each one of the brackets 100C, 100D, 100E, 100F should be large enough to accept enough adhesive to form a strong bond with the surface of the teeth. The shape of the base pad may be such that it furthers this goal. A preferred technique for mounting a bracket 100 is to place bracket 100 on the surface of a tooth directly with a cotton plier and a plugger instrument.

FIG. 6 shows a profile view of upper teeth 20 and lower teeth 30 exhibiting anterior openbite malocclusion. As shown, a bracket 100A according to the present invention is mounted on a tooth in the row of upper front teeth 20 and another bracket 100B according to the present invention is mounted on a tooth in the row of lower front teeth 30. It is to be noted that a spur 130A and spur 130B are positioned to oppose the tongue.

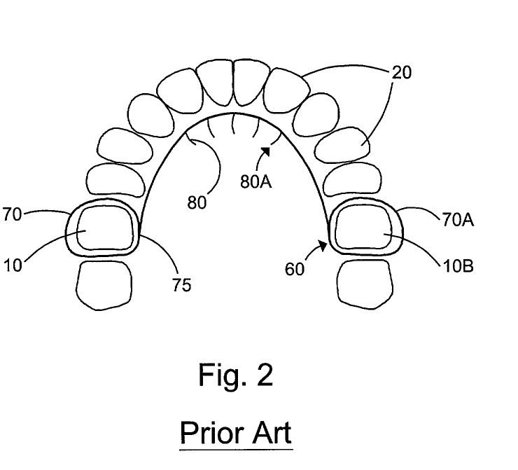

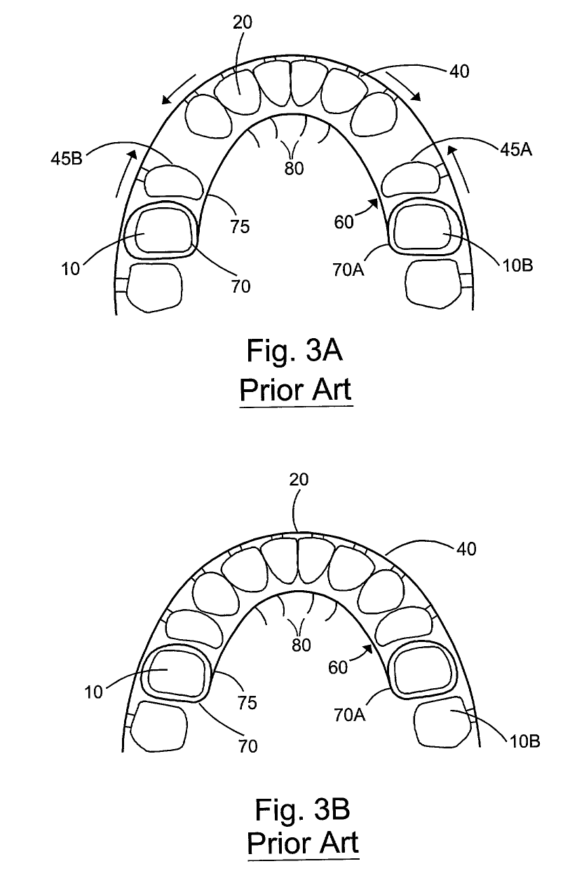

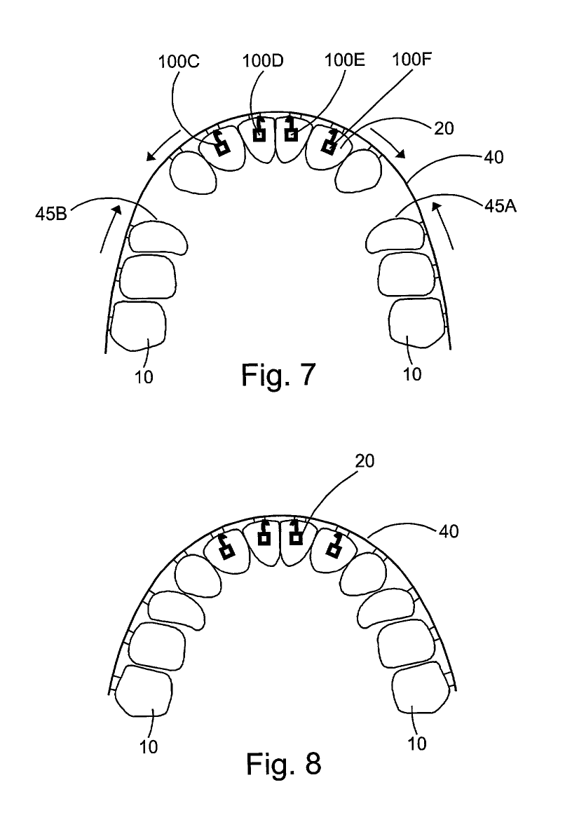

Referring to FIGS. 7 and 8, when brackets 100C, 100D, 100E, 100F are individually mounted on the teeth of a patient who also has a brace 40, no readjustment of the position of brackets 100C, 100D, 100E, 100F becomes necessary when brace 40 is readjusted for example to close gaps 45A, 45B (as shown by the arrows) between the teeth. When the brackets 100C, 100D, 100E, 100F are mounted on teeth that are not repositioned by the closing of the gaps between the teeth. This is because, unlike the rake-like device of the prior art which needs to be adjusted to ensure the proper positioning of its spur portions (see FIGS. 3A and 3B) when the brace is adjusted, the position of the brackets do not need to be changed. This also spares the patient the discomfort of adjustment and reinstallation which is normally associated with rake-like devices. Additionally, a method of prevention of openbite malocclusion according to the present invention also provides more room for a patient's tongue because the brackets are placed flush against the teeth instead of being located on a wire (e.g., 75, FIG. 2) set away from the teeth.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A bracket for orthodontic use comprising:
a base, the base having a face adapted to be mounted to an inside surface of a tooth; and
a stem having a first end connected to the base, the stem including a spur connected to a second end of the stem such that when the base is mounted to the inside surface of the tooth, the spur is located rearwardly of the face and oriented in the rearward direction.

2. A bracket according to claim 1, wherein the stem further includes an extension rod connected to the spur.

3. A bracket according to claim 1, further comprising a mesh pad disposed on the face.

4. A bracket according to claim 1, wherein the stem is cylindrical.

5. A bracket according to claim 1, wherein the spur has a rounded distal end.

6. A bracket according to claim 2, wherein the extension rod is malleable.

7. A bracket according to claim 2, wherein the extension rod is substantially parallel to the face of the base.

8. A bracket according to claim 1, wherein the spur is oriented substantially orthogonally to the face of the base.

9. A bracket according to claim 1, wherein the base, and the stem are unitarily connected.

10. A bracket according to claim 1, wherein the base has a surface that has an area, the area being less than an area of an inside surface of the tooth.

11. A method for prevention of anterior openbite malocclusion comprising:
providing a bracket having a spur;
mounting the bracket on a rear surface of a tooth that is substantially opposing the tongue; and
orienting the spur in a direction substantially opposing the tongue to discourage tongue thrust during swallowing.

12. A method according to claim 11, wherein the bracket is adhesively mounted on the rear surface of the tooth by a dental adhesive.

13. A method according to claim 12, wherein at least one of the brackets includes a mesh pad disposed on a face of the base.

14. A method according to claim 13, wherein the dental adhesive is applied to the mesh pad.

15. A method according to claim 12, wherein the dental adhesive is one of a self-cured dental adhesive and a light-cured dental adhesive.

16. A method according to claim 11, wherein a plurality of brackets having respective spurs are provided, and each is mounted on a respective rear surface of a tooth that is substantially opposing the tongue, and the respective spurs of the plurality of brackets are oriented in a direction substantially opposing the tongue to discourage tongue thrust during swallowing.

17. A method according to claim 16, wherein the tooth is one of an upper front tooth and a lower front tooth.

18. A method according to claim 17, wherein each bracket includes a base and the spur of each bracket is oriented in a direction away from the base.

19. A method for prevention of anterior openbite malocclusion comprising:
mounting a bracket having a base and a spur extending in a direction away from the base onto a rear surface of a tooth substantially opposing the tongue in a manner to position the spur opposite to the tongue to discourage tongue thrust during swallowing.

20. A method according to claim 19, wherein the bracket is adhesively mounted.

21. A method according to claim 20, wherein the tooth is one of an upper front tooth and a lower front tooth.

22. A method according to claim 19, wherein a plurality of brackets are each adhesively mounted onto a rear surface of a respective one of an upper front tooth or a lower front tooth.
